(19) United States
(12) Patent Application Publication
(10) Pub. No.: US 2019/0003538 A1
(43) Pub. Date: Jan. 3, 2019

(54) BRAKE CLIP FOR DISC BRAKE ASSEMBLY AND DISC BRAKE ASSEMBLY INCLUDING SUCH A BRAKE CLIP

(71) Applicant: KELSEY-HAYES COMPANY, Livonia, MI (US)

(72) Inventors: Kraig E. GERBER, Plymouth, MI (US); Chad BRIZENDINE, Livonia, MI (US)

(73) Assignee: Kelsey-Hayes Company, Livonia, MI (US)

(21) Appl. No.: 16/064,495

(22) PCT Filed: Dec. 19, 2016
(86) PCT No.: PCT/US2016/067446

§ 371 Date: Jun. 21, 2018

Related U.S. Application Data
(60) Provisional application No. 62/270,116, filed on Dec. 21, 2015.

(51) Int. Cl. F16D 65/097; F16D 65/00; F16D 65/092

(52) U.S. Cl. CPC F16D 65/0978; F16D 2055/0016; F16D 65/092; F16D 65/0068

(57) ABSTRACT

A disc brake assembly includes a brake clip having a U-shaped section and a plurality of dimples. The U-shaped section has a base leg and opposing upper and lower legs extending from the base leg. The plurality of dimples is on the upper leg and extend in a direction from the lower leg to the upper leg.

### BACKGROUND OF INVENTION

This invention relates in general to vehicle disc brake assemblies and in particular to an improved structure for a brake clip for use in such a disc brake assembly.

Most vehicles are equipped with a brake system for slowing or stopping movement of the vehicle in a controlled manner. A typical brake system for an automobile or light truck includes a disc brake assembly for each of the front wheels and either a drum brake assembly or a disc brake assembly for each of the rear wheels. The brake assemblies are actuated by hydraulic or pneumatic pressure generated when an operator of the vehicle depresses a brake pedal. The structures of these drum brake assemblies and disc brake assemblies, as well as the actuators therefore, are well known in the art.

Typical disc brake assemblies include a rotor, a caliper, and an anchor bracket. The rotor is secured to the wheel of the vehicle for rotation therewith and includes a pair of opposed friction plates. The caliper includes a pair of brake pads which are disposed on opposite sides of the brake rotor. The anchor bracket is attached to a non-rotatable component of the vehicle, such as the vehicle frame. The caliper is slidably supported on the anchor bracket by guide pins.

The brake pads are connected to one or more hydraulically or pneumatically actuated pistons for movement between a non-braking position, wherein they are spaced apart from the opposed friction plates of the rotor, and a braking position, wherein they are moved into frictional engagement with the opposed friction plates of the rotor. When the operator of the vehicle depresses the brake pedal, the piston urges the brake pads from the non-braking position to the braking position so as to frictionally engage the friction plates of the rotor and thereby slow or stop the rotation of the associated wheel of the vehicle.

When in the non-braking position, the brake pads are normally spaced apart from the opposite sides of the rotor. Because the brake pads are not positively engaged with the rotor, the brake pads are free to move relative to other brake and vehicle components during vehicle operation. As a result, vehicle induced vibration loads are known to cause undesirable rattle or other noises between the brake pads and the other brake components. To prevent this from occurring, it is known to provide at least one brake clip between the anchor bracket and the brake pad.

However, during acceleration because of road inputs—e.g., potholes or cobblestones, the brake clip may separate from the anchor bracket. This separation produces undesirable motion by the brake pads. Thus, it would be desirable to have a brake clip which reduces motion of the brake pads because of road inputs.

### SUMMARY OF INVENTION

This invention relates to a brake clip for use in a disc brake assembly.

According to one embodiment, a disc brake assembly may comprise, individually and/or in combination, one or more of the following features: a brake clip having a U-shaped section and at least one dimple. The U-shaped section has a base leg and opposing upper and lower legs extending from the base leg. The at least one dimple is on the upper leg and extends away from the lower leg.

According to this embodiment, the disc brake assembly may further comprise an anchor bracket and wherein the brake clip is installed on the anchor bracket and the at least one dimple contacts the anchor bracket, and air gap, between the upper leg and the anchor bracket, that established by the at least one dimple.

According to this embodiment, the disc brake assembly may further comprise a support leg extending from the upper leg, a first length of the support leg; and a second length of the base leg, wherein the first and second lengths are parallel and overlap.

According to this embodiment, the disc brake assembly may further comprise a coating on a backside of the brake clip, wherein the backside of the brake clip is configured to abut an anchor bracket upon which the brake clip is installed.

According to another embodiment, a disc brake assembly may comprise, individually and/or in combination, one or more of the following features: a brake clip having a U-shaped section and a plurality of dimples. The U-shaped section has a base leg and opposing upper and lower legs extending from the base leg. The plurality of dimples is on the upper leg and extend in a direction from the lower leg to the upper leg.

According to this embodiment, the plurality of dimples comprises first and second dimples.

According to this embodiment, the first dimple is a first distance from a first edge of the upper leg, the second dimple is a second distance from a second edge of the upper leg, and the first and second distances are equal.

According to this embodiment, the plurality of dimples further comprises a third dimple.

According to this embodiment, the first and second dimples are on an axis and the third dimple is offset from the axis.

According to this embodiment, the third dimple is a first height from a first edge of the upper leg and a second height from a second edge of the upper leg, wherein the first and second heights are unequal.

According to this embodiment, the first and second dimples extend a first height in the direction, the third dimple extends a second height in the direction, and the first height is greater than the second height.

According to this embodiment, a first dimple of the plurality of dimples extends further in the direction than a second dimple of the plurality of dimples.

According to this embodiment, the disc brake assembly may further comprise an anchor bracket, wherein the brake clip is installed on the anchor bracket and the plurality of dimples contact the anchor bracket and an air gap is between the upper leg and the anchor bracket.

According to this embodiment, the disc brake assembly may further comprise at least one brake pad supported on the brake clip and a brake caliper slidably supported on the anchor bracket.

According to this embodiment, the disc brake assembly may further comprise a support leg extending from the upper leg, a first length of the support leg; a second length of the base leg, and a third length from an upper vertical extent of the support leg to a lower vertical extent of the base leg, wherein the upper vertical extent is a point of the support leg furthest from the base leg, the lower vertical extent is a point of the base leg furthest from the support leg, the first, second, and third lengths are parallel, and a sum of the first and second lengths is greater than the third length.

According to this embodiment, the disc brake assembly may further comprise a coating on a backside of the brake clip, wherein the backside of the brake clip is configured to abut an anchor bracket upon which the brake clip is installed.

According to another embodiment, a disc brake assembly may comprise, individually and/or in combination, one or more of the following features: a brake clip having a U-shaped section and a contact point. The U-shaped section has a base leg and opposing upper and lower legs extending from the base leg. The contact point is on the upper leg and extends from a surface of the upper leg. The contact point extends in a direction from the lower leg to the upper leg and the surface faces away from the lower leg.

According to this embodiment, the disc brake assembly may further comprise a support leg extending from the upper leg, wherein the contact point extends from the upper leg between the support leg and the base leg.

According to this embodiment, the disc brake assembly may further comprise an anchor bracket, wherein the brake clip is installed on the anchor bracket and the contact point contacts the anchor bracket and an air gap is between the upper leg and the anchor bracket.

According to this embodiment, the upper leg and the contact point have an equal thickness.

A potential advantage of an embodiment of the brake clip is damping which reduces undesirable motion of the brake pad because of road inputs. Other advantages of this invention will become apparent to those skilled in the art from the following detailed description of the preferred embodiments, when read in light of the accompanying drawings.

### BRIEF DESCRIPTION OF DRAWINGS

FIG. 1 is an exploded perspective view of a disc brake assembly including a first embodiment of a brake clip in accordance with the present invention.

FIG. 2 is a perspective view of the brake clip illustrated in FIG. 1.

FIG. 3 is a section view taken along line 3-3 of FIG. 2 and includes a portion of an anchor bracket illustrated in FIG. 1.

FIG. 4 is a section view taken along line 4-4 of FIG. 2.

FIG. 5 is a perspective view of a second embodiment of a brake clip in accordance with the present invention.

FIG. 6 is a section view taken along line 6-6 of FIG. 5.

FIG. 7 is a section view of a third embodiment of a brake clip in accordance with the present invention.

FIG. 8 is a perspective view of a fourth embodiment of a brake clip in accordance with the present invention.

### DETAILED DESCRIPTION OF THE PREFERRED EMBODIMENTS

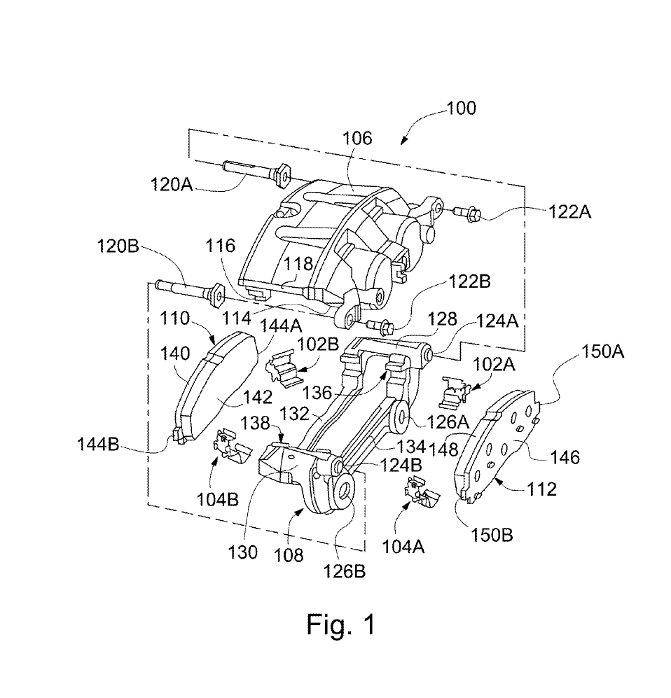

Referring now to FIG. 1, there is illustrated selected components of a disc brake assembly, indicated generally at 100, including inboard and outboard first brake clips, indicated generally at 102A and 102B, respectively, and inboard and outboard second brake clips, indicated generally at 104A and 104B, respectively. The disc brake assembly 100 illustrated in FIG. 1 is a well known “Collete” sliding type of disc brake assembly, such as that shown in U.S. Pat. No. 5,323,882 to Waterman et al., U.S. Patent No. Re 30,255 to Rath et al., U.S. Patent Publication No. 2013/0192938 to Miller et al., the disclosures of all of these patents and publication are incorporated by reference in entirety herein.

The general structure and operation of the disc brake assembly 100 is conventional in the art. Thus, only those portions of the disc brake assembly 100 which are necessary for a full understanding of this invention will be explained and illustrated in detail. Also, although this invention will be described and illustrated in connection with the particular disc brake assembly 100 disclosed herein, it will be appreciated that this invention may be used in connection with other types of disc brake assemblies. For example, the invention may be used in conjunction with other single piston, twin piston, single opposed piston and twin opposed piston disc brake assemblies, such as shown for example in U.S. Pat. No. 7,784,591 to Franz et al., the disclosure of which is incorporated by reference in entirety herein.

The disc brake assembly 100 includes a generally C-shaped caliper 106, an anchor bracket indicated generally at 108, and outboard and inboard brake pads, indicated generally at 110 and 112, respectively. The disc brake assembly 100 is illustrated as being adapted for use on a front left wheel of a vehicle, although such is not required.

The caliper 106 includes an inner section 114 and an outer section 116 connected by a bridge section 118. The caliper 106 is slidably supported on the anchor bracket 108 by first and second guide pins 120A and 120B, respectively, which extend into the anchor bracket 108. The caliper 106 can be secured to the first and second guide pins 120A and 120B, respectively, by first and second guide pin bolts 122A and 122B, respectively. The anchor bracket 108 is, in turn, secured to a stationary component of the vehicle, such as for example an axle flange (not shown) or a steering knuckle (also not shown).

The anchor bracket 108 includes first and second spaced apart non-threaded openings 124A and 124B, respectively, and first and second spaced apart threaded openings 126A and 126B, respectively. The first and second non-threaded openings 124A and 124B, respectively, are each adapted to receive one of the associated first or second guide pins 120A or 120B, respectively. The first and second threaded openings 126A and 126B, respectively, are each adapted to receive a mounting bolt (not shown). The mounting bolts extend through the first and second threaded openings 126A and 126B, respectively, and are received in threaded openings provided in the stationary vehicle component (not shown), thereby securing the anchor bracket 108 to the stationary vehicle component. Alternatively, other known securing methods can be used to secure the caliper 106 to the anchor bracket 108 and/or to secure the anchor bracket 108 to the stationary vehicle component if so desired.

The anchor bracket 108 also includes a pair of axially and outwardly extending first and second arms 128 and 130, respectively, that are interconnected at their outboard ends by an outer tie bar 132 and interconnected at their inboard ends by an inner tie bar 134. The first arm 128 is at the first end of the disc brake assembly 100 and the second arm 130 is at the second end of the disc brake assembly 100. Alternatively, the anchor bracket 108 can be constructed to include only one of the outer tie bar 132 or inner tie bar 134 if so desired.

Each of the first and second arms 128 and 130, respectively, includes first and second spaced apart notches or channels, indicated generally at 136 and 138, respectively, formed therein (only the first channels 136 are clearly shown, but the second channels 138 are preferably identical to the first channels 136). In particular, the first channels 136 are provided on an inner wall of the first arm 128 and are parallel to one another, and the second channels 138 are provided on an inner wall of the second arm 130 and are parallel to one another. The first and second channels 136 and 138, respectively, slidably support the outboard brake pad 110 and the inboard brake pad 112 having the inboard and outboard first brake clips 102A and 102B, respectively, and the inboard and outboard second brake clips 104A and 104B, respectively, assembled therewith. Thus, the first and second channels 136 and 138, respectively, are adapted to receive the associated inboard and outboard first brake clips 102A and 102B, respectively, and the associated inboard and outboard second brake clips 104A and 104B, respectively, prior to assembly of the outboard and inboard brake pads 110 and 112, respectively, to the anchor bracket 108.

The outboard brake pad 110 includes an outboard backing plate 140 and an outboard brake friction pad 142. The outboard backing plate 140 includes opposite ends having outwardly projecting first and second outboard guide rails 144A and 144B, respectively, (only the second outboard guide rail 144B is shown clearly) formed thereon. The first and second outboard guide rails 144A and 144B, respectively, are configured to support the outboard brake pad 142 for sliding movement within the first and second channels 136 and 138, respectively, of the anchor bracket 108.

Similarly, the inboard brake pad 112 includes an inboard backing plate 146 and an inboard friction pad 148. The inboard backing plate 146 includes opposite ends having outwardly projecting first and second inboard guide rails 150A and 150B, respectively, formed thereon. The first and second inboard guide rails 150A and 150B, respectively, are configured to support the inboard brake pad 112 for sliding movement within the first and second channels 136 and 138, respectively, of the anchor bracket 108. Alternatively, the outboard brake pad 110 can be supported on a brake piston of the disc brake assembly 100 while the inboard brake pad 112 can be supported on the inner section 114 of the caliper 106. In the illustrated embodiment, the first and second outboard guide rails 144A and 144B, respectively, and the first and second inboard guide rails 150A and 150B, respectively, each preferably have a generally rectangular cross sectional shape, although such is not required.

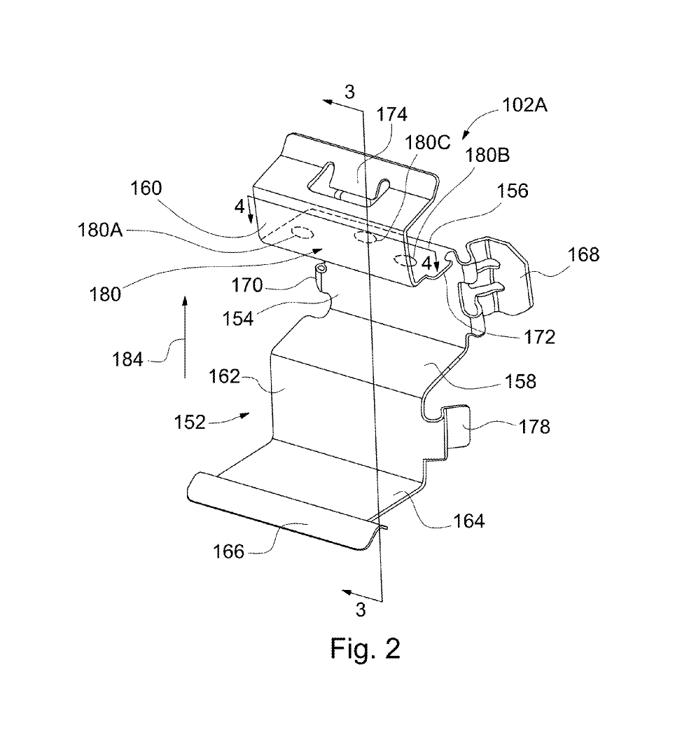

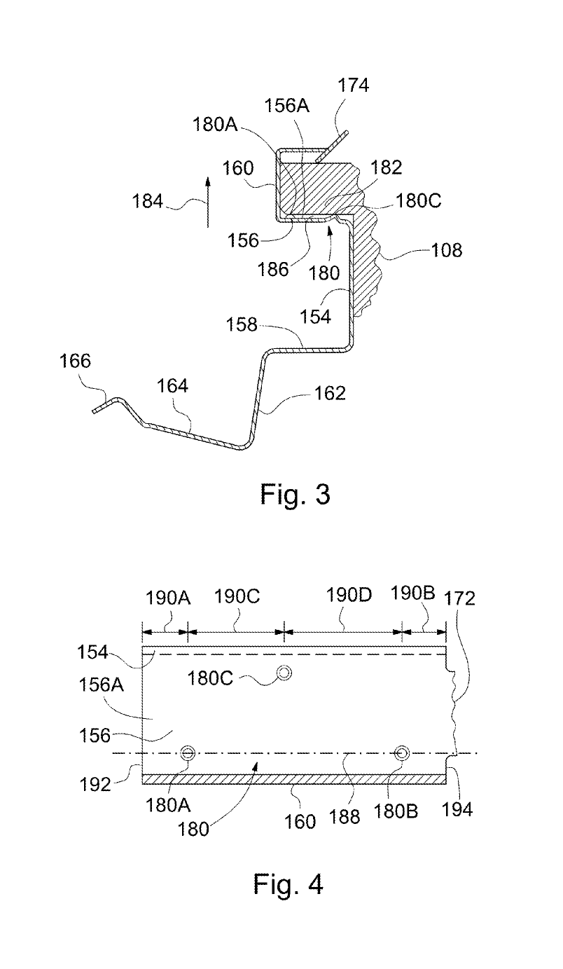

Referring now to FIGS. 2-4, there is illustrated the inboard first brake clip 102A. As will be readily understood by one skilled in the art, although only the inboard first brake clip 102A is described and illustrated in FIGS. 2 and 3, the outboard first brake clip 102B, as well as the inboard and outboard second brake clips 104A and 104B, respectively, are similar.

The brake clip 102A includes a body section, indicated generally at 152, having a substantially flat base leg 154. A first or upper leg 156 and a second or lower leg 158 extend outwardly from opposing edges of the base leg 154. The upper leg 156 and the lower leg 158 are generally parallel with one another and perpendicular with the base leg 154, thereby forming a rectangular shape that corresponds with the shape of the first channel 136, although such is not required. When the brake clip 102A is installed on the anchor bracket 108, the rectangular shape of the base leg 154, the upper leg 156, and the lower leg 158 is seated in the first channel 136.

A support leg 160 extends from the upper leg 156 and is configured to generally correspond with and extend adjacent to a front surface of the anchor bracket 108 when the brake clip 102A is installed on the anchor bracket 108, although such is not required. As such, the support leg 160 is disposed between the anchor bracket 108 and the inboard backing plate 146 when the associated components of the disc brake assembly 100 are assembled. As illustrated, the support leg 160 is substantially parallel to the base leg 154 and perpendicular to the upper leg 156, although such is not required.

An abutment leg 162 extends downwardly in a generally perpendicular manner from the lower leg 158, although such a configuration is not required. Thus, when the brake clip 102A is installed on the anchor bracket 108, the abutment leg 162 extends adjacent a lower contact surface of the anchor bracket 108 and is preferably in contact with at least a portion of the lower contact surface. The abutment leg 162 may be a resilient member.

An extension leg 164, in turn, extends from the abutment leg 162. The extension leg 164 is a resilient member that extends outwardly from the lower leg 158. An end portion of the extension leg 164 may include a lip portion 166 having a semi-circular cross-sectional shape or any other desired cross-sectional shape. The lip portion 166 is provided to assist in deflection of the extension leg 164.

A first side guide 168 extends from the base leg 154. A second side guide 170 also extends from the base leg 154, opposite the first side guide 168. The first and second side guides 168 and 170, respectively, are resilient portions. When the brake clip 102A is installed on the anchor bracket 108, the first and second side guides 168 and 170, respectively, engage side surfaces of the anchor bracket 108 to assist in securing the brake clip 102A to the anchor bracket 108.

As illustrated, the brake clip 102A further includes an optional upper installation tab 172. The installation tab 172 extends outwardly from a side of the upper leg 156 and is angled upwardly therefrom. The installation tab 172 aligns the first inboard guide rail 150A into the first channel 136 during installation of the inboard brake pad 112 on the anchor bracket 108.

A retention tang 174 extends from an upper leg of the support leg 160. When the brake clip 102A is installed on the anchor bracket 108, the retention tang 174 frictionally engages with the anchor bracket 108 to secure the brake clip 102A to the anchor bracket 108.

The abutment leg 162 further preferably includes a retention member 178 on an outboard side thereof, although such is not required. The illustrated retention member 178 is a resilient projection that extends from the abutment leg 162 along a side surface of the anchor bracket 108. The retention member 178 opposes a retraction load that is created by retraction of the inboard backing plate 146 relative to the anchor bracket 108. Thus, the retention member 178 prevents the inboard backing plate 146 from pulling the brake clip 102A toward a rotor (not shown) as the friction material of the inboard brake pad 112 wears from use. Further, the retention member 178 may assist in alignment of the abutment leg 162 on the lower contact surface of the anchor bracket 108 when the brake clip 102A is installed thereon. It should be appreciated that the retention member 178 may include a lip, a protrusion, a tab, or any other structural feature that is configured to contact the side surface of the anchor bracket 108 if so desired.

A plurality of defined contact points, indicated generally at 180, is on the upper leg 156. Although the defined contact points 180 are illustrated as dimples, the defined contact points 180 may be structures other than dimples that extend from the upper leg 156. For example, the defined contact points 180 may be ridges or other shapes that extend from the upper leg 156. Alternatively, the defined contact points 180 may comprise a single dimple or other shape. Alternatively, the defined contact points 180 may be fabricated or formed separately from the upper surface 156 and then fixed to, or otherwise placed with, the upper surface 156. Discussion of the dimples also applies to the other shapes for the defined contact points 180.

As illustrated, the plurality of defined contact points 180 comprises a first dimple 180A, a second dimple 180B, and a third dimple 180C. In FIG. 2, the first and third dimples 180A and 180C, respectively, as well as a portion of the second dimple 180B, are illustrated with dashed hidden lines. Alternatively, the plurality of defined contact points 180 may comprise greater or less than the three dimples illustrated. When the brake clip 102A is installed on the anchor bracket 108, the first, second, and third dimples 180A, 180B, and 180C, respectively, contact an underside 182 of the anchor bracket 108 such that an air gap or clearance 186 is established between the underside 182 and the upper leg 156.

The first, second, and third dimples 180A, 180B, and 180C, respectively, extend from the upper leg 156 in a direction 184. The direction 184 is from the lower leg 158 to the upper leg 156. Specifically, the first, second, and third dimples 180A, 180B, and 180C, respectively, extend from a surface 156A of the upper leg 156 and away from the lower leg 158. The surface 156A faces away from the lower leg 158. The first, second, and third dimples 180A, 180B, and 180C, respectively, extend from the upper leg 156 between the base leg 154 and the support leg 160. A thickness of the upper leg 156 is continued through the first, second, and third dimples 180A, 180B, and 180C, respectively—i.e., a thickness of the first, second, and third dimples 180A, 180B, and 180C, respectively, is substantially equal to a thickness of the upper leg 156.

As illustrated, each of the first, second, and third dimples 180A, 180B, and 180C, respectively, extends an equal height from the upper leg 156. Alternatively, the first, second, and third dimples 180A, 180B, and 180C, respectively, may extend for unequal heights from the upper leg 156 to bias contact between the brake clip 102A and the anchor bracket 108. For example, the first and second dimples 180A and 180B, respectively, may extend a first height that is greater than a second height that the third dimple 180C extends. Furthermore, each of the first, second, and third dimples 180A, 180B, and 180C, respectively, may extend a different height or the first, second, and third dimples 180A, 180B, and 180C, respectively, may extend in various combinations of heights. For example, the first and third dimples 180A and 180C, respectively, may extend for equal heights that are different from a height that the second dimple 180B extends.

The first and second dimples 180A and 180B, respectively, are aligned on an axis 188 that is parallel to the base leg 154 and support leg 160. As such, the first and second dimples 180A and 180B, respectively, are equal distances from the support leg 160. The third dimple 180C is offset from the axis 188.

The first dimple 180A is positioned a first distance 190A from a first edge 192 of the upper leg 156 and the second dimple 180B is positioned a second distance 190B from a second edge 194 of the upper leg 156. As illustrated, the first distance 190A and the second distance 190B are equal, although the first distance 190A and the second distance 190B may also be other than equal.

As illustrated, the third dimple 180C is closer to the first edge 192 than the second edge 194 such that a third distance 190C is less than a fourth distance 190D. Alternatively, the third dimple 180C may be positioned other than as illustrated. For example, the third distance 190C may be greater than the fourth distance 190D or the third and fourth distances 190C and 190D, respectively, may be equal. As a sum of the third and fourth distances 190C and 190D, respectively, increases, a load capacity of the brake clip 102A increases.

Specific planar positions of the first, second, and third dimples 180A, 180B, and 180C, respectively, on the upper leg 156, as well as geometric relationships between the first, second, and third dimples 180A, 180B, and 180C, respectively, may be different than as illustrated and described.

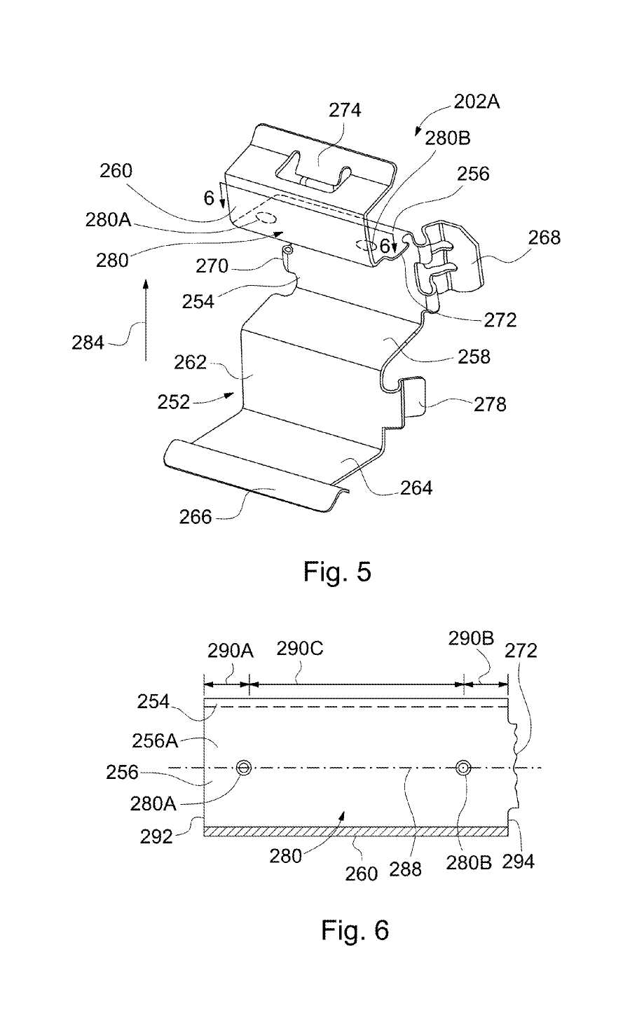

Referring now to FIGS. 5 and 6, there is illustrated a second embodiment of a brake clip, indicated generally at 202A, produced in accordance with the present invention. Because the brake clip 202A is a variation of the inboard first brake clip 102A of FIGS. 1-4, like reference numerals, increased by 100, designate corresponding parts in the drawings and detailed description thereof will be omitted.

The brake clip 202A has a plurality of defined contact points, indicated generally at 280. The defined contact points 280 comprise a first dimple 280A and a second dimple 280B. As illustrated, the first and second dimples 280A and 280B, respectively, are on an axis 288 and the axis 288 is spaced equally between a base leg 254 and a support leg 260. As illustrated, the first and second dimples 280A and 280B, respectively, are a third distance 290C apart.

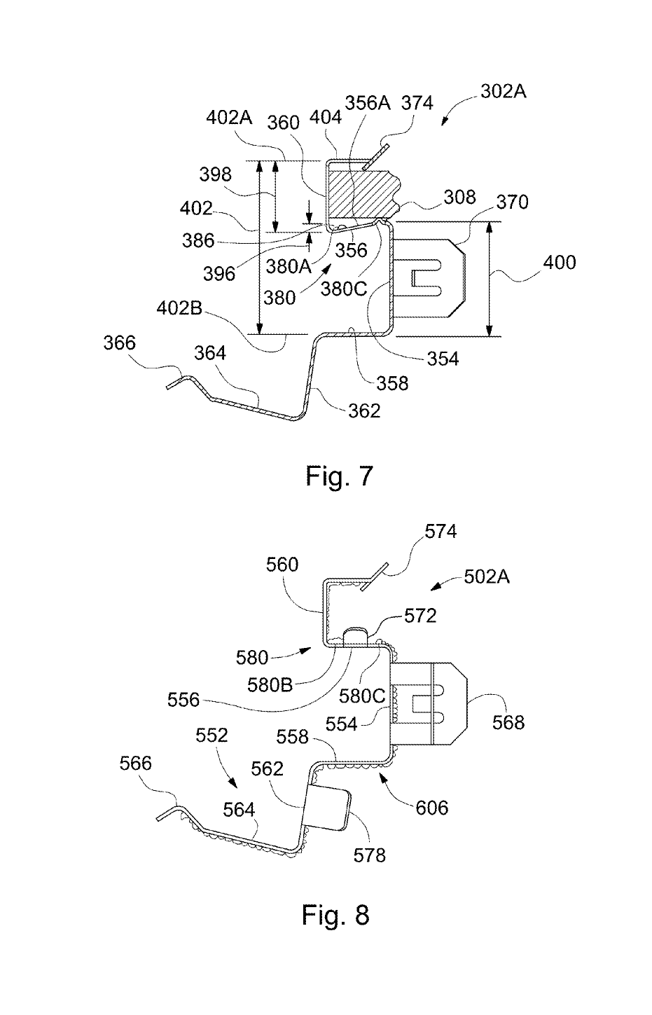

Referring now to FIG. 7, there is illustrated a third embodiment of a brake clip, indicated generally at 302A, produced in accordance with the present invention. Because the brake clip 302A is a variation of the inboard first brake clip 102A of FIGS. 1-4, like reference numerals, increased by 200, designate corresponding parts in the drawings and detailed description thereof will be omitted.

An upper leg 356 is angled towards a lower leg 358 such that a base leg 354 and a support leg 360 have an overlap region 396. The overlap region 396 produces an air gap or clearance 386 between the brake clip 302A and an anchor bracket 308 on which the brake clip 302A is installed.

Alternatively, the upper leg 356 may be angled towards the lower leg 358 with the support leg 360 omitted. For example, a distance between the upper leg 356 and the lower leg 358 may increase from the base leg 354 or the distance between the upper leg 356 and the lower leg 358 may decrease from the base leg 354. For either example, the support leg 360 may be omitted.

The support leg 360 has a first vertical length 398 and the base leg 354 has a second vertical length 400. A third vertical length 402 is from an upper vertical extent 402A of the support leg 360 furthest from the base leg 354 to a lower vertical extent 402B of the base leg 354 furthest from the support leg 360—i.e., the third length 402 is from an upper portion 404 of the support leg 360 to a lower leg 358. The first, second, and third lengths 398, 400, and 402, respectively, are parallel. A sum of the first and second lengths 398 and 400, respectively, is greater than the third length 402. The third length 402 exceeds the sum of the first and second lengths 398 and 400, respectively, by a length of the overlap region 396.

Referring now to FIG. 8, there is illustrated a fourth embodiment of a brake clip, indicated generally at 502A, produced in accordance with the present invention. Because the brake clip 502A is a variation of the inboard first brake clip 102A of FIGS. 1-4, like reference numerals, increased by 400, designate corresponding parts in the drawings and detailed description thereof will be omitted.

The brake clip 502A has a coating, indicated generally at 606 by “wavy” lines. The coating 606 is applied to a side of the brake clip 502A that abuts an anchor bracket (not shown) after installation of the brake clip 502A on the anchor bracket. As non-limiting examples, the coating 606 may be an elastic or rubber material. As a non-limiting example, the coating 606 may be nitrile rubber.

In accordance with the provisions of the patent statutes, the principle and mode of operation of this invention have been described and illustrated in its preferred embodiments. However, it must be understood that this invention may be practiced otherwise than as specifically explained and illustrated without departing from its spirit or scope.

What is claimed is:

1. A disc brake assembly comprising:
a brake clip having:
a U-shaped section having a base leg and opposing upper and lower legs extending from the base leg; and
at least one dimple on the upper leg, wherein the at least one dimple extends away from the lower leg.

2. The disc brake assembly of claim 1 further comprising:
an anchor bracket, wherein the brake clip is installed on the anchor bracket and the at least one dimple contacts the anchor bracket; and
an air gap, between the upper leg and the anchor bracket, that is established by the at least one dimple.

3. The disc brake assembly of claim 1 further comprising:
a support leg extending from the upper leg;
a first length of the support leg; and
a second length of the base leg, wherein the first and second lengths are parallel and overlap.

4. The disc brake assembly of claim 1 further comprising:
a coating on a backside of the brake clip, wherein the backside of the brake clip is configured to abut an anchor bracket upon which the brake clip is installed.

5. A disc brake assembly comprising:
a brake clip having:
a U-shaped section having a base leg and opposing upper and lower legs extending from the base leg; and
a plurality of dimples on the upper leg, wherein the plurality of dimples extend in a direction from the lower leg to the upper leg.

6. The disc brake assembly of claim 5 wherein the plurality of dimples comprises first and second dimples.

7. The disc brake assembly of claim 6 wherein the first dimple is a first distance from a first edge of the upper leg, the second dimple is a second distance from a second edge of the upper leg, and the first and second distances are equal.

8. The disc brake assembly of claim 6 wherein the plurality of dimples further comprises a third dimple.

9. The disc brake assembly of claim 8 wherein the first and second dimples are on an axis and the third dimple is offset from the axis.

10. The disc brake assembly of claim 8 wherein the third dimple is a first height from a first edge of the upper leg and a second height from a second edge of the upper leg, wherein the first and second heights are unequal.

11. The disc brake assembly of claim 8 wherein the first and second dimples extend a first height in the direction, the third dimple extends a second height in the direction, and the first height is greater than the second height.

12. The disc brake assembly of claim 5 wherein a first dimple of the plurality of dimples extends further in the direction than a second dimple of the plurality of dimples.

13. The disc brake assembly of claim 5 further comprising:
an anchor bracket, wherein the brake clip is installed on the anchor bracket and the plurality of dimples contact the anchor bracket; and
an air gap between the upper leg and the anchor bracket.

14. The disc brake assembly of claim 13 further comprising:
at least one brake pad supported on the brake clip; and
a brake caliper slidably supported on the anchor bracket.

15. The disc brake assembly of claim 5 further comprising:
a support leg extending from the upper leg;
a first length of the support leg;
a second length of the base leg; and
a third length from an upper vertical extent of the support leg to a lower vertical extent of the base leg, wherein the upper vertical extent is a point of the support leg furthest from the base leg, the lower vertical extent is a point of the base leg furthest from the support leg, the first, second, and third lengths are parallel, and a sum of the first and second lengths is greater than the third length.

16. The disc brake assembly of claim 5 further comprising:
a coating on a backside of the brake clip, wherein the backside of the brake clip is configured to abut an anchor bracket upon which the brake clip is installed.

17. A disc brake assembly comprising:
a brake clip having:
a U-shaped section having a base leg and opposing upper and lower legs extending from the base leg; and
a contact point of the upper leg that extends from a surface of the upper leg, wherein the contact point extends in a direction from the lower leg to the upper leg and the surface faces away from the lower leg.

18. The disc brake assembly of claim 17 further comprising:
a support leg extending from the upper leg, wherein the contact point extends from the upper leg between the support leg and the base leg.

19. The disc brake assembly of claim 17 further comprising
an anchor bracket, wherein the brake clip is installed on the anchor bracket and the contact point contacts the anchor bracket; and
an air gap between the upper leg and the anchor bracket.

20. The disc brake assembly of claim 17 wherein the upper leg and the contact point have an equal thickness.
